(19) United States
(12) Patent Application Publication
(10) Pub. No.: US 2002/0069484 A1
(43) Pub. Date: Jun. 13, 2002

(54) Rotatable handle structure for hand held tool

(76) Inventor: Greg S. Creel, Williamston, SC (US)

Correspondence Address: JAMES M. ROBERTSON, 233 SOUTH PINE STREET, SPARTANBURG, SC, 29302, US

(21) Appl. No.: 09/995,359

(22) Filed: Nov. 27, 2001

Related U.S. Application Data
(60) Provisional application No. 60/253,521, filed on Nov. 28, 2000.

(51) Int. Cl. B62B 1/00

(52) U.S. Cl. 16/430

(57) ABSTRACT

A handle for a hand held tool which includes a main body portion adapted to engage an elongate tool element and a rotatable portion disposed behind the main body portion. The rotatable portion of the handle may be rotated relative to the main body portion of the handle without imparting rotational movement to the elongate tool element. The rotatable portion of the handle includes a digit acceptance opening for insertion of one or more fingers by the operator so as to maintain contact between the hand of the operator and the handle during use of the tool.

### CROSS-REFERENCE TO RELATED APPLICATION

This application claims priority benefit from U.S. Provisional Application 60/253,521 filed Nov. 28, 2000.

### TECHNICAL FIELD

This invention relates to a manually powered hand held tool, and more particularly to a hand held tool which can be simultaneously supported and axially rotated using one hand.

### BACKGROUND OF THE INVENTION

Hand held tools such as screwdrivers, torque wrenches, nut drivers, utility knives, saws, and files are well known. Such tools typically include an elongate shaft or blade element for performing a desired function attached to a handle gripped by the operator. Such handles are typically of a substantially solid construction fixedly attached to the elongate shaft or blade element. Such tools are operated by the hand driven reciprocating or rotational movement of the handle structure so as to impart a corresponding movement to the elongate shaft or blade element attached thereto.

In the event that the hand tool is to perform a function which is dependent upon rotational movement of an elongate shaft element, it is generally necessary for the operator to apply a rotational force to the handle so as to rotate the handle and the attached shaft element through an angle. However, the extent of such angular rotation is limited by the fact that the hand and the wrist of the operator can only move through a finite angle. Thus, in the event that the shaft element is to be rotated through an extended angle which exceeds the angle which can be applied by the wrist of the operator, it is necessary for the operator to release and thereafter regrip the handle so as to permit extended rotation. It may be necessary for such release and regripping of the handle to take place multiple times during operation of the tool. Each time the tool is released and regriped there arises an enhanced potential that the tool may be dropped or that the engagement between the working portion of the shaft element and the work piece may be lost.

In some instances, it may be possible for the operator to use a second hand to support and stabilize the tool during the regripping operation. However, in the event that the tool is being operated within a cramped space or in the event that the operator does not have a second hand available for use in the stabilizing operation, the use of a second hand may not represent a viable solution.

The prior art has sought to address these problems by providing hand held tools which include a freely rotatable end cap structure on the handle which can be gripped in a substantially prehensile fashion by the small finger and ring finger of the operator while the thump and index finger simultaneously manipulate the main portion of the handle. However, the operation of such a configuration requires substantial dexterity which may not be possessed by many users. In addition, since the prehensile grip on the rotatable cap may be difficult to maintain, the problems associated with dropping the tool may not be eliminated.

### SUMMARY OF THE INVENTION

This invention provides advantages and alternatives over the prior art by providing a hand held tool including a handle which includes a main body portion adapted to engage an elongate tool element and a rotatable portion disposed behind the main body portion. The rotatable portion of the handle may be rotated relative to the main body portion of the handle without imparting rotational movement to the elongate tool element. The rotatable portion of the handle includes a digit acceptance opening for insertion of one or more fingers by the operator so as to maintain contact between the hand of the operator and the handle during use of the tool. The digit acceptance opening within the rotatable portion of the handle may be either of a substantially fixed dimension or may be of an adjustable dimension.

These advantages are accomplished in a potentially preferred form of the invention by providing a hand held tool including a handle having a main body portion and a finger grip portion disposed behind the main body portion such that the finger grip portion is rotatable relative to the main body portion of the handle during operation of the hand tool. The finger grip portion of the handle may be a fixed opening within a segment of the handle disposed above the main body portion or may be an adjustable digit acceptance opening such as an adjustable loop or strap structure.

The main body portion of the handle may include laterally projecting torque enhancement elements which extend outwardly from the sides of the main body of the handle so as to provide the user with the ability to generate enhanced torque on the main body of the handle during use. Such laterally projecting torque enhancement elements are preferably foldable into the main body of the handle so as to facilitate compact storage.

In accordance with still a further potentially preferred aspect of the invention, the main body portion of the handle may be adapted to releasably engage elongate tool elements of various configurations such that the handle is useful in a wide array of operations.

Advantageously, the present invention permits the user to maintain enhanced control over the operation of the hand tool in instances when only a single hand is available to carry out such operation. In addition, in the event that the laterally projecting torque enhancement elements are utilized, the operator may be able to gain an enhanced mechanical advantage while using a single hand. In addition, in the event that a releasable attachment mechanism is utilized, a single handle may be used in interchangeable fashion with a wide variety of elongate tool elements so as to permit a large number of different functions to be carried out.

### BRIEF DESCRIPTION OF THE DRAWINGS

The accompanying drawing which are incorporated in and which constitute a part of this specification, illustrate several potentially preferred embodiments of the present invention and together with the general description of the invention given above and the detailed description set forth below, serve to explain the principles of the invention wherein:

FIG. 1 is a view of a first embodiment of a hand held tool assembly incorporating a finger acceptance opening of substantially fixed dimension disposed in a rotatable structure above the main body portion of the tool handle;

FIG. 2 is a view similar to FIG. 1 but incorporating a finger acceptance opening of substantially adjustable dimension;

FIG. 3 is a surface view of a hand held tool assembly as illustrated in FIG. 2 but incorporating retractable torque enhancement arms and a releasable tool element engagement assembly;

FIG. 4 is a detailed cut-away view of a hand held tool assembly illustrating details of retractable torque enhancement arms and a releasable engagement assembly to effect operative connection between the handle and an elongate tool element; and

FIGS. 5A-5G illustrate various illustrative elongate tool elements as may be incorporated within a hand held tool in accordance with the present invention.

While the invention has been illustrated and generally described above and will hereinafter be described in greater detail in connection with certain potentially preferred embodiments, constructions, and procedures, it is to be understood that in no even is the invention intended to be limited to such illustrated and described embodiments, constructions, or procedures. On the contrary, it is intended that the present invention shall extend to all alternatives and modifications as may embrace the principles of this invention within the true spirit and scope thereof.

### DESCRIPTION OF THE PREFERRED EMBODIMENTS

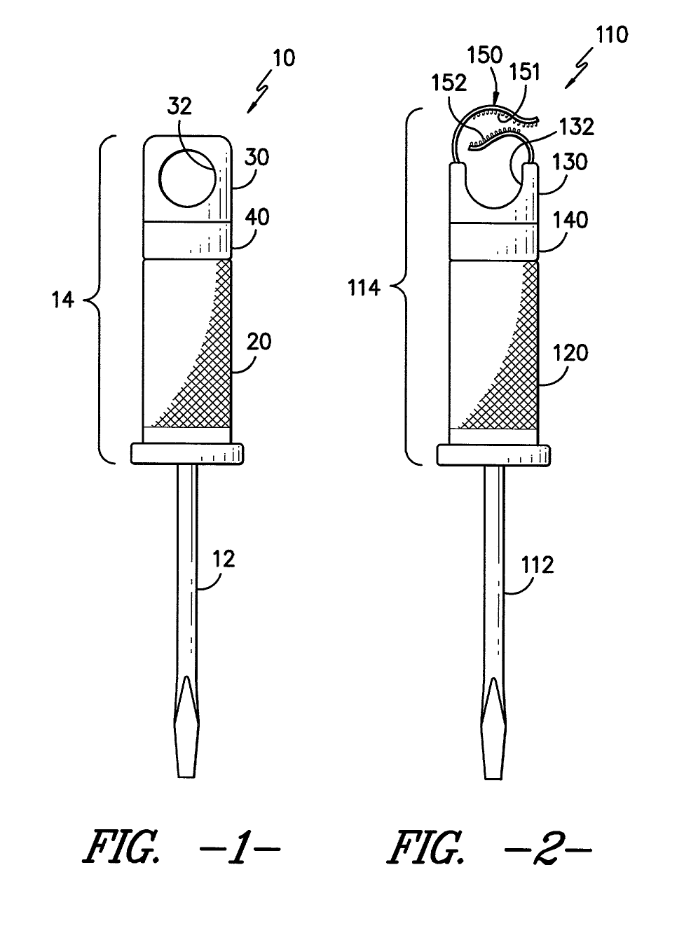

Turning now to the drawings wherein to the extent possible like reference numerals are utilized to designate like components throughout the various views, in FIG. 1 there is illustrated a hand held tool 10 such as a screwdriver or the like including an elongate tool element 12 and a handle structure 14 of segmented construction for operative engagement with the elongate tool element 12.

According to a potentially preferred embodiment of the present invention, the handle structure 14 includes a main body portion 20 operatively connected to the elongate tool element 12 such that the application of rotation to the main body portion 20 results in a substantially corresponding angular rotation to the elongate tool element 12. As will be described further hereinafter, the operative engagement between the main body portion 20 and the elongate tool element 12 may be either of a substantially fixed or of a releasable nature.

Disposed at a position above the main body portion 20 (i.e. away from the elongate tool element 12) is a digit acceptance portion 30 which includes a finger acceptance opening 32 disposed therein. As will be appreciated, the presence of the finger acceptance opening 32 within the digit acceptance portion 30 permits a user to insert one or more fingers into the finger acceptance opening during operation of the hand tool 10 thereby permitting the operator to establish and maintain contact with the hand tool 10 using a single hand. According to the potentially preferred operation of the hand tool 10, the operator will insert his or her smallest finger and/or ring finger into the finger acceptance opening thereby leaving his or her thumb, index finger, and/or middle finger free to engage in manipulation of the main body portion 20 of the handle structure 14 in the manner as will now be described.

As indicated previously, the handle structure 14 is preferably of a substantially segmented construction such that the main body portion 20 and the digit acceptance portion 30 may be rotated relative to one another. According to the illustrated and potentially preferred practice of the present invention, such relative rotation may be achieved through use of a slip bushing 40 between the digit acceptance portion 30 and the main body portion 20 although other mechanisms for achieving such desired relative rotation as may be known to those of skill in the art may also be utilized. Regardless of the actual mechanism which is utilized to establish the relative rotation between the digit acceptance portion 30 and the main body portion 20 of the handle structure 14, such relative rotation permits the efficient manipulation of the main body portion 20 by the digits which are not inserted into the finger acceptance opening 32 while nonetheless permitting a stable and substantially uninterrupted engagement between the digit acceptance portion 30 and the hand of the operator. Thus, in the event that the operator is engaged in the manipulation of the main body portion 20 of the handle structure 14 by use of his or her thumb and index finger the operator may simultaneously use his or her small finger and/or ring finger to hold the overall tool 10 in place. Moreover, in the event that the operator loses contact with the main body portion 20, the chance that the hand held tool 10 will be dropped is greatly reduced due to the insertion of one or more fingers through the finger acceptance opening 32.

It is contemplated that the handle structure 14 may be formed of any material suitable to achieve efficient molding and grip characteristics for the operator. Plastic materials affording substantial insulation to electric shock may be particularly preferred. It is further contemplated that the materials forming the main body portion 20 and the digit acceptance portion 30 of the handle structure 14 may be formed of dissimilar materials if desired. By way of example only, and not limitation, it is contemplated that the main body portion may be formed of a relatively rigid plastic material while the digit acceptance portion 30 may be formed from a much softer plastic or rubber material such that the finger acceptance opening 32 may stretch or contract to form fit fingers of different sizes while maintaining a high level of user comfort.

In FIG. 2 there is illustrated an alternative embodiment wherein elements of like nature to those previously described are designated by like reference numerals increased by 100. As shown, the hand held tool 110 in FIG. 2 is substantially similar to the hand held tool illustrated in FIG. 1 with the exception that the finger acceptance opening 132 may be opened or closed by manipulation of a releasable closure 150. As shown, according to one potentially preferred embodiment, the releasable closure may constitute a double ended strap construction wherein the ends of the strap may incorporate complimentary hook and loop fabrics 151, 152 which may be aligned and joined together to enclose around fingers of various sizes. As shown, in the event that such a releasable closure is utilized, it is contemplated that the digit acceptance portion 130 of the handle structure 114 will preferably incorporate a substantially concave curved profile so as to facilitate the placement and maintenance of the fingers of the operator within the finger acceptance opening 132.

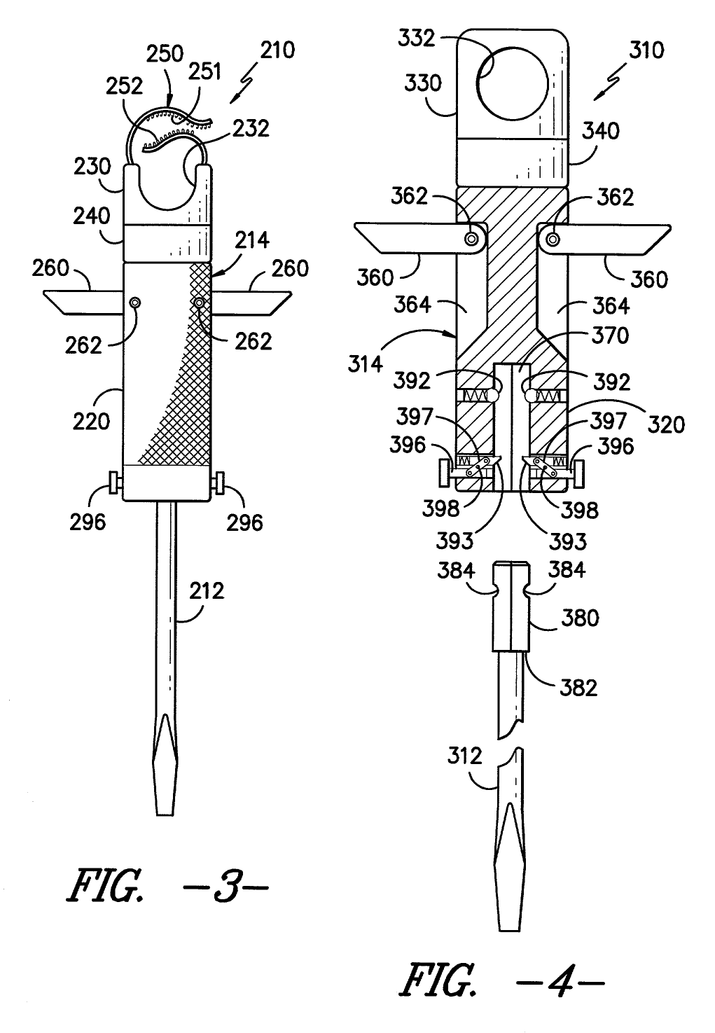

Yet another embodiment is illustrated in FIG. 3 wherein elements corresponding the those previously described are designated by like reference numerals increased by 200. As illustrated, according to this embodiment, the main body portion 220 of the handle structure 214 includes laterally projecting torque enhancement arms 260 which project in opposing directions outwardly from the main body portion 220 as shown. As will be appreciated, the torque enhancement arms 260 provide the operator with a mechanical advantage based upon the distance they extend away from the axis of rotation. That is, such torque enhancement arms 260 provide a moment arm of extended length such that for a given force applied along the moment arm, the magnitude of the moment around the axis of rotation is increased proportionally to the length of the moment arm. In order to facilitate storage and to enhance versatility of operation, it is contemplated that the torque enhancement arms may retract and extend around a pivot axis 262 and may be folded inwardly into storage compartments within the main body portion 220 so as to be substantially flush with the outer surface of the main body portion 220 when in the retracted state. Thus, in instances where enhanced torque may be desirable, the user may manually fold the torque enhancement arms 260 away from the main body portion 220. Likewise, in the event that enhanced torque is not required and/or that space limitations prevent the extension of the torque enhancement arms 260, such torque enhancement arms 260 may be maintained in stored condition within the main body portion 220.

It is contemplated that the handle structure 214 may be adapted to releasably accept and retain the elongate tool element 212 which may be normally stored separately from the handle structure 214. By way of example only, it is contemplated that acceptance and retention of the tool element 212 may be effected by providing the handle structure 214 with an internal acceptance chamber with a substantially straight-edged cross-sectional geometry such as a hexagonal geometry or the like and by providing the elongate tool element 212 with a complementary shank portion of a size and cross-sectional geometry which corresponds substantially to the size and cross-section of the acceptance chamber. In order to prevent the unintentional premature withdrawal of the elongate tool element 212 from the handle structure 214, it is contemplated that depressable spring biased release elements 296 as described further hereinafter may be incorporated within the handle structure 214 although a simple friction fit is also contemplated as being satisfactory.

A cross-sectional breakaway view of a handle structure 314 illustrating exemplary embodiments of torque enhancement arms 360 as well as spring biased release elements 396 is shown in FIG. 4 wherein elements corresponding to those previously described are designated by like reference numerals increased by 300. While the handle structure 314 is illustrated as incorporating a finger acceptance opening 332 of fixed dimension within the digit acceptance portion 330, it is to be understood that such finger acceptance openings may also be of variable dimension if desired.

As shown, in the illustrated embodiment, the handle structure 314 may be provided with elongate storage compartments 364 into which the torque enhancement arms may be folded around pivot axis 362 for storage and retrieval. The handle structure 314 further includes an elongate tool element acceptance chamber 370 into which a shank portion 380 of the elongate tool element 312 may be inserted. The tool element acceptance chamber 370 and the shank portion 380 are preferably of substantially complementary size and cross-sectional geometry. Substantially straight sided polygonal geometries having three and about ten sides may be preferred. A hexagonal geometry may be particularly preferred.

As shown, it is contemplated that the handle structure 314 includes chamfered surfaced spring loaded locking pins 393 which may be pushed aside as the shank portion 380 is inserted into the acceptance chamber 370 but which spring into blocking relation with respect to the lower edge 382 of the shank portion once the shank portion is fully inserted into the acceptance chamber 370. In addition, stability of the elongate tool element 312 within the handle structure 314 may be further enhanced by the incorporation of at least one pair of spring loaded ball elements 392 which cooperatively engage corresponding indentures 384 within the shank portion 380 of the elongate tool element 312.

As shown, the spring loaded locking pins 393 are preferably connected to depressable release buttons 396 by a linking pin 397. The linking pins 397 pivot about pivot points 398 located between the locking pins 393 and the release buttons 396 such that upon depression of the release buttons 396, the locking pins 393 are moved out of engagement with the lower edge 382 of the shank portion 380 thereby permitting the withdrawal of the tool element 312. As will be appreciated, the ability to insert and withdraw elongate tool elements 312 of different constructions permits the operator to carry out a number of different functions using a single handle structure 314.

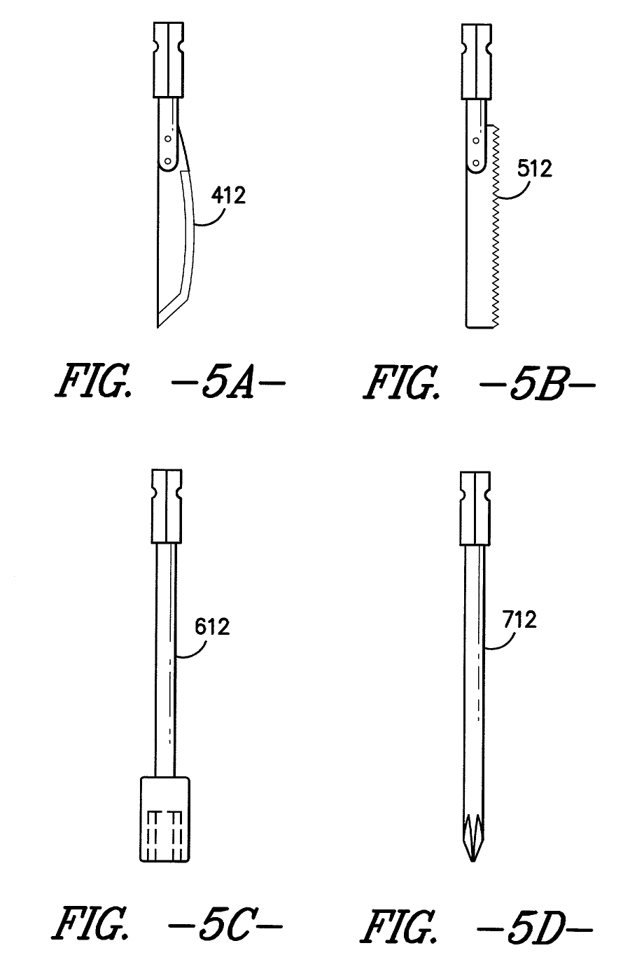

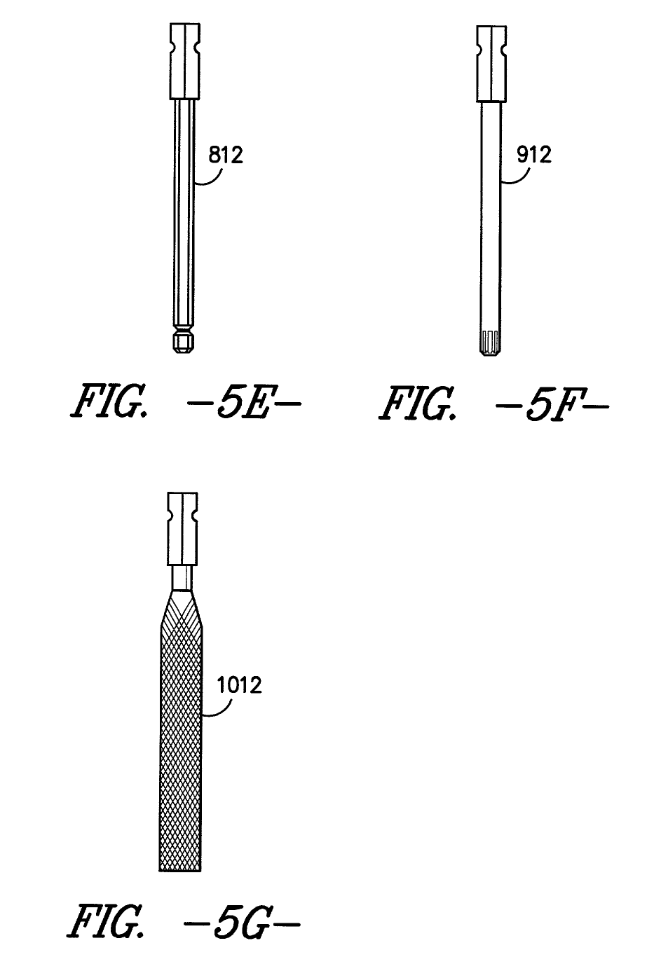

In the event that variety of functions are to be carried out, it is contemplated that any number of different elongate tool elements may be utilized. By way of example only, and not limitation, FIGS. 5A-5G illustrate configurations for various elongate tool elements as may be incorporated within the present invention. More specifically, in FIG. 5A, there is illustrated a knife blade 412, in FIG. 5B there is illustrated a saw blade 512, in FIG. 5C there is illustrated a nut driver 612, in FIG. 5D there is illustrated a Phillips head screwdriver 712, in FIG. 5E there is illustrated an Allen wrench 812, in FIG. 5F there is illustrated a star wrench 912, and in FIG. 5G there is illustrated a file 1012. Of course, it is contemplated that any number of other devices which may be operated by hand motion may also be incorporated within the present invention.

It is to be understood that while the present invention has been illustrated and described in relation to several exemplary and potentially preferred embodiments that such embodiments are illustrative only and that the present invention is in no event to be limited thereto. Rather, it is contemplated that modifications and variations embodying the general principles of this invention will no doubt occur to those of skill in the art. It is thus contemplated and intended that the present invention shall extend to all such modifications and variations as may incorporate the broad aspects of this invention within the full spirit and scope of the appended claims and all equivalents thereto.

1. A handle structure for a hand held tool, said handle structure being adapted to support an elongate tool element extending away from said handle structure, said handle structure comprising: a first portion adapted to hold said elongate tool element in place such that rotation of said first portion is translated to said elongate tool element and a second portion rotatable relative to said first portion, wherein said second portion includes a digit acceptance opening through which an operator may insert at least one finger such that said operator may rotate said first portion and said elongate tool element while maintaining said at least one finger within said digit acceptance opening.

2. A handle structure according to claim 1, wherein said elongate tool element is selected from the group consisting of: a flat head screw driver, a Phillips head screw driver; a knife blade; a saw blade; a nut driver; an Allen wrench; and a star wrench.

3. A handle structure according to claim 1, wherein said elongate tool element is normally supported in fixed relation within said first portion.

4. A handle structure according to claim 1, wherein said first portion is adapted to releaseably engage said elongate tool element.

5. A handle structure according to claim 1, wherein said digit acceptance opening comprises an aperture of substantially fixed dimensions extending through said second portion.

6. A handle structure according to claim 1, wherein said digit acceptance opening is of variable size.

7. A handle structure according to claim 6, wherein said digit acceptance opening comprises an expansible aperture extending through said second portion.

8. A handle structure according to claim 6, wherein an adjustable strap element extends at least partially around said digit acceptance opening such that said adjustable strap defines a variable boundary for said digit acceptance opening.

9. A handle structure according to claim 1, further comprising at least one pair of torque enhancing arm elements operatively connected to said first portion.

10. A handle structure according to claim 9, wherein said torque enhancing arm elements are selectively foldable within storage compartments within said handle structure.

11. A handle structure for a hand held tool, said handle structure being adapted to releaseably engage an elongate tool element such that said elongate tool element extends away from said handle structure, said handle structure comprising: a first portion adapted to engage and hold said elongate tool element in place such that rotation of said first portion is translated to said elongate tool element, said first portion including an elongate acceptance chamber extending inwardly from one end of the handle structure, wherein said acceptance chamber has an internal size and shape corresponding substantially to the size and shape of a portion of said elongate tool element for sliding insertion within said acceptance chamber, said handle structure further comprising a second portion rotatable relative to said first portion, wherein said second portion includes a digit acceptance opening through which an operator may insert at least one finger such that said operator may rotate said first portion and said elongate tool element while maintaining said at least one finger within said digit acceptance opening,

12. A handle structure according to claim 11, further comprising at least one pair of torque enhancing arm elements operatively connected to said first portion.

13. A handle structure according to claim 12, wherein said torque enhancing arm elements are selectively foldable within storage compartments within said handle structure.

14. A handle structure according to claim 11, wherein a plurality of spring biased pin elements normally extend into said acceptance chamber, such that said pin elements engage said elongate tool element within said acceptance chamber, and wherein said pin elements are selectively retractable to disengage from said elongate tool element.

15. A handle structure according to claim 14, further comprising at least one pair of torque enhancing arm elements operatively connected to said first portion.

16. A handle structure according to claim 15, wherein said torque enhancing arm elements are selectively foldable within storage compartments within said handle structure.

17. A hand held tool, comprising in combination: a handle structure and an elongate tool element supported by and extending away from said handle structure, said handle structure comprising a first portion adapted to hold said elongate tool element in place such that rotation of said first portion is translated to said elongate tool element and a second portion rotatable relative to said first portion, wherein said second portion includes a digit acceptance opening through which an operator may insert at least one finger such that said operator may rotate said first portion and said elongate tool element while maintaining said at least one finger within said digit acceptance opening.
